(19) United States
(12) Patent Application Publication
(10) Pub. No.: US 2026/0323699 A1
(43) Pub. Date: Oct. 15, 2026

(54) TXSPG GROUP IDENTIFICATION INFORMATION CONTROL PROCEDURE

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Plano, TX (US); Bilal Sadiq, Plano, TX (US)

(21) Appl. No.: 19/632,062

(22) Filed: Mar. 27, 2026

Related U.S. Application Data
(60) Provisional application No. 63/786,770, filed on Apr. 10, 2025.

(51) Int. Cl. H04W 74/0816; H04W 28/02; H04W 76/14

(52) U.S. Cl. CPC H04W 74/0816; H04W 28/0268; H04W 76/14

(57) ABSTRACT

Methods and apparatuses for transmit opportunity (TXOP) sharing for a peer to peer (P2P) group (TXSPG) group identification information control procedure. A method performed by an access point (AP) includes receiving, from a non-AP station (STA), a stream classification service (SCS) request frame requesting a transmission opportunity (TXOP) allocation for a peer to peer (P2P) group of the non-AP STA, where the non-AP STA supports transmission opportunity sharing for peer to peer group (TXSPG). The method includes transmitting, to the non-AP STA, a SCS response frame indicating acceptance of the SCS request frame, the SCS response frame including an identifier for the P2P group assigned by the AP.

### CROSS-REFERENCE TO RELATED APPLICATIONS AND CLAIM OF PRIORITY

This application claims priority under 35 U.S.C. § 119 (e) to U.S. Provisional Patent Application No. 63/786,770 filed on Apr. 10, 2025. The above-identified provisional patent application is hereby incorporated by reference in their entirety.

### TECHNICAL FIELD

This disclosure relates generally to wireless networks. More specifically, this disclosure relates to transmit opportunity (TXOP) sharing for a peer to peer (P2P) group (TXSPG) group identification information control procedure.

### BACKGROUND

WLAN technology allows devices to access the internet in the 2.4 GHZ, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for a TXSPG group identification information control procedure.

In one embodiment, a method performed by an access point (AP) includes receiving, from a non-AP station (STA), a stream classification service (SCS) request frame requesting a transmission opportunity (TXOP) allocation for a peer to peer (P2P) group of the non-AP STA, wherein the non-AP STA supports transmission opportunity sharing for peer to peer group (TXSPG). The method includes transmitting, to the non-AP STA, a SCS response frame indicating acceptance of the SCS request frame, the SCS response frame including an identifier for the P2P group assigned by the AP.

In another embodiment, a method performed by a non-AP STA includes transmitting, to an AP, an SCS request frame requesting a TXOP allocation for a P2P group of the non-AP STA, wherein the non-AP STA supports TXSPG. The method includes receiving, from the AP, a SCS response frame indicating acceptance of the SCS request frame, the SCS response frame including an identifier for the P2P group assigned by the AP.

In yet another embodiment, an AP is provided. The AP includes at least one processor including processing circuitry and memory storing instructions. The instructions, when executed by the at least one processor individually or collectively, cause the AP to receive, from a non-AP STA, an SCS request frame requesting a TXOP allocation for a P2P group of the non-AP STA. The non-AP STA supports TXSPG. The instructions, when executed by the at least one processor individually or collectively, further cause the AP to transmit, to the non-AP STA, a SCS response frame indicating acceptance of the SCS request frame, the SCS response frame including an identifier for the P2P group assigned by the AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIG. 3 illustrates an example network where infrastructure traffic and non-infrastructure traffic coexist according to embodiments of the present disclosure;

FIG. 4 illustrates an example format of a P2P element according to embodiments of the present disclosure;

FIG. 5 illustrates an example format of a P2P Group Info field according to embodiments of the present disclosure;

FIG. 6 illustrates a diagram for exchanges of the SCS Request/Response frames for TXOP allocation request/response in TXSPG operation according to embodiments of the present disclosure;

FIG. 7 illustrates a flow diagram of a process for an SCS response that carries an identifier using SCS Request/Response frames according to embodiments of the present disclosure; and

FIG. 8 illustrates an example method performed by an AP according to embodiments of the present disclosure.

### DETAILED DESCRIPTION

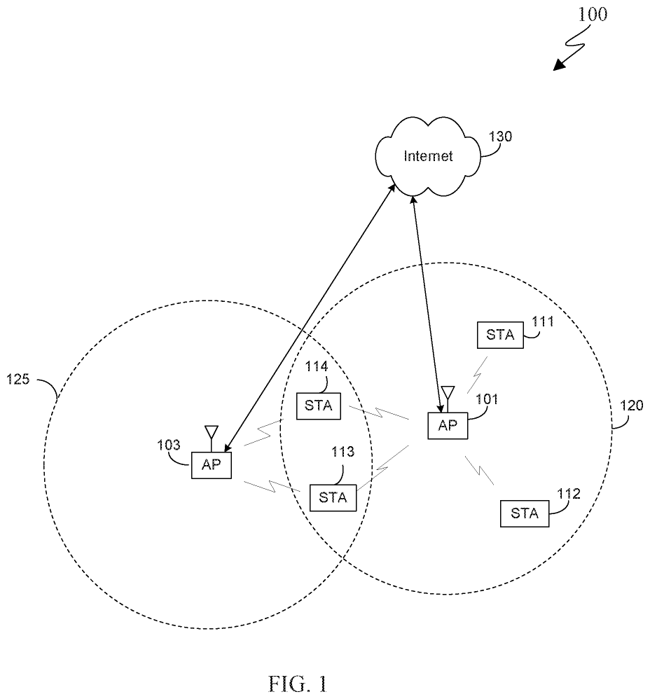

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an AP and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be—D3.0 “Part 11: Wireless LAN Medium Access Control (MAC) and Physical Layer (PHY) Specifications—Amendment 8: Enhancements for extremely high throughput (EHT)” and [2] IEEE P802.11REVme—D2.1“Part 11: Wireless LAN Medium Access Control (MAC) and Physical Layer (PHY) Specifications.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for a TXSPG group identification information control procedure. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

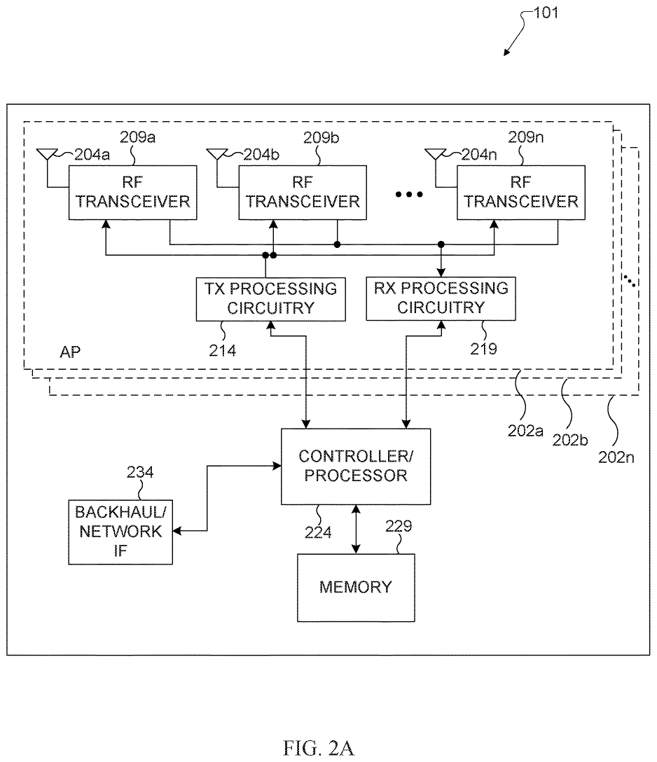

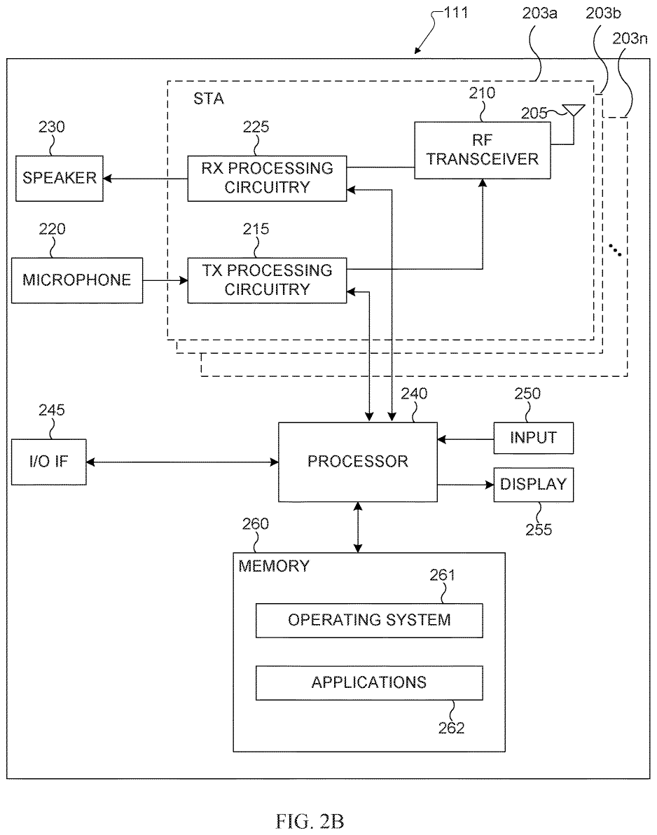

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In one or more of the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including a TXSPG group identification information control procedure. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for a TXSPG group identification information control procedure. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In one or more of the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate a TXSPG group identification information control procedure. In some embodiments, the processor 240 includes at least one microprocessor or microcontroller.

The processor 240 is also capable of executing other processes and programs resident in the memory 260, such as operations for a TXSPG group identification information control procedure. The processor 240 can move data into or out of the memory 260 as required by an executing process. In some embodiments, the processor 240 is configured to execute a plurality of applications 262, such as applications for a TXSPG group identification information control procedure. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that support for low-latency applications is desired in WLAN systems. Numerous devices may operate on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other's traffic interference may be due to transmission in the neighboring infrastructure BSS (OBSS). Yet other's traffic interference may be coming from neighboring independent BSS or P2P networks.

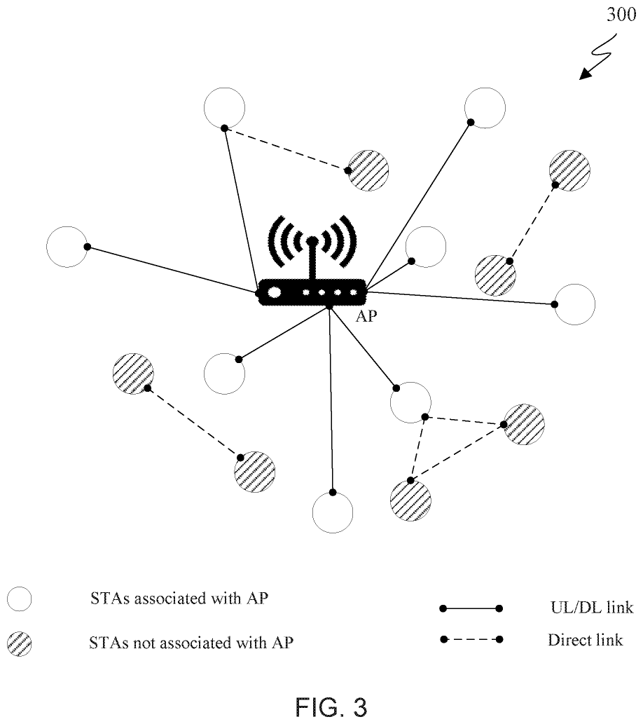

FIG. 3 illustrates an example network 300 where infrastructure traffic and non-infrastructure traffic coexist according to embodiments of the present disclosure. The network 300 is an example of the network 100 in FIG. 1. The network 300 is for illustration only and other embodiments can be used without departing from the scope of the present disclosure.

As illustrated, various STAs are present in the network 300. Certain of the STAs are connected to or associated with the AP. In this manner, the traffic between the associated STAs and the APs may be considered infrastructure traffic. Others of the STAs in the network 300 are not associated with the AP and may communicate directly with one another and/or with an associated STA using P2P communication. P2P communication represents a significant advancement in IEEE 802.11 WLANs, commonly known as Wi-Fi. Wi-Fi networks may rely on an AP to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

There are multiple benefits of P2P groups. By eliminating the need for an AP, they reduce latency and conserve battery life on devices. This makes them good for scenarios requiring real-time communication or energy efficiency. Additionally, P2P groups enable innovative applications such as smart home systems and IoT networks, where direct device interaction is important.

Despite these advantages, embodiments of the present disclosure recognize that challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, may provide some framework for these P2P capabilities. These standards ensure compatibility and security, often incorporating encryption methods like WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

Various embodiments of the present disclosure recognize that TXSPG is an important feature for IEEE 802.11bn (Wi-Fi) and that the SCS procedures for TXSPG may not be clear and in need of definition. Accordingly, various embodiments of the present disclosure provide mechanisms for a TXSPG group identification information control procedure.

Various embodiments further provide for and describe signaling aspects related to one or more embodiments disclosed herein. According to one embodiment, a P2P group Information field can be added in the QoS Characteristics element. The P2P group Information field may contain an identifier that would uniquely identify the P2P group.

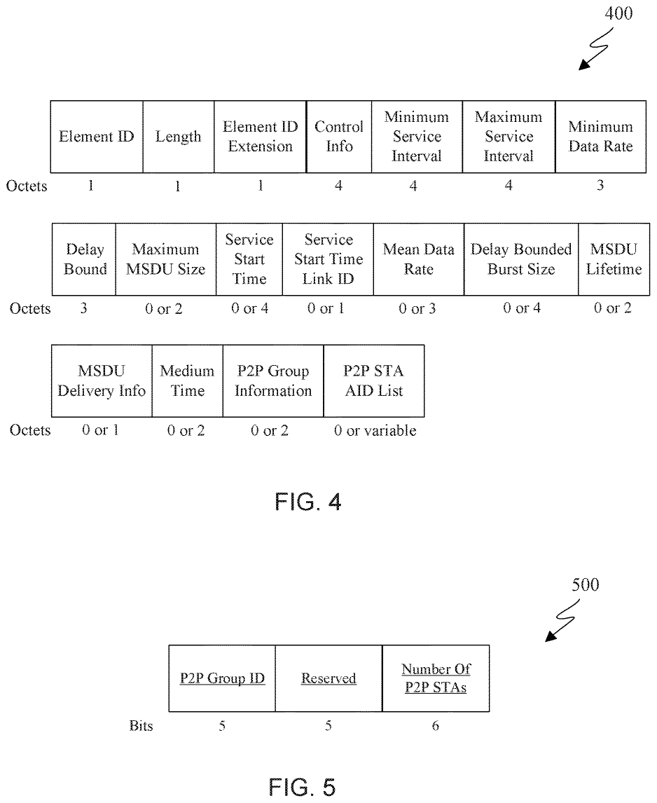

FIG. 4 illustrates an example format of a P2P element 400 according to embodiments of the present disclosure. The example format of the P2P element 400 are for illustration only. Other embodiments could be used without departing from the scope of this disclosure.

As illustrated in FIG. 4, the P2P element 400 includes a control info field that includes a direction subfield as discussed above. An example format of the direction subfield in the Control field is shown in Table 1 below.

TABLE 1
Direction subfield encoding

| Direction | Usage |
|---|---|
| 0 | Uplink, defined as follows: |
| | MSDUs or A-MSDUs are sent from the non-AP |
| | STA to the AP. |
| 1 | Downlink, defined as follows: |
| | MSDUs or A-MSDUs are sent from the AP to |
| | the non-AP STA. |
| 2 | Direct link (MSDUs or A-MSDUs are sent over a peer- |
| | to-peer link). |
| 3 | P2P group |
| | MSDUs or A-MSDUs are sent over a peer-to- |
| | peer links within the addressed P2P group. |

The P2P Group Information field may be present if the Direction subfield is set to 3 (P2P group); otherwise, it is not present.

FIG. 5 illustrates an example format of a P2P Group Info field 500 according to embodiments of the present disclosure. The example format of the P2P Group Info field 500 is for illustration only. Other embodiments could be used without departing from the scope of this disclosure.

An example P2P Group Info field format is illustrated in FIG. 5. The identifier for the P2P group subfield identifies the P2P group for which the traffic characteristics is described by this element. The Number Of P2P STAs subfield indicates the number of the P2P STAs, excluding the STA that sends the QoS Characteristics element, that are members of the P2P group identified by the identifier for the P2P group subfield and for which traffic characteristics described by this element applies. The remaining bits of the P2P STA AID List till the nearest octet value are reserved.

The P2P STA AID List field, if present, contains one or more AID12 subfields corresponding to the AID12 values of the STAs that are members of the P2P group and for which the traffic characteristics is described by this element. The AID12 subfield is encoded and may be as defined in Table 9-46i of [1] (AID12 subfield encoding) and have a value between 1 and 2006. The number of AID12 subfields present in the P2P STA AID List field is identified by the Number of P2P STAs field in the P2P Group Info field.

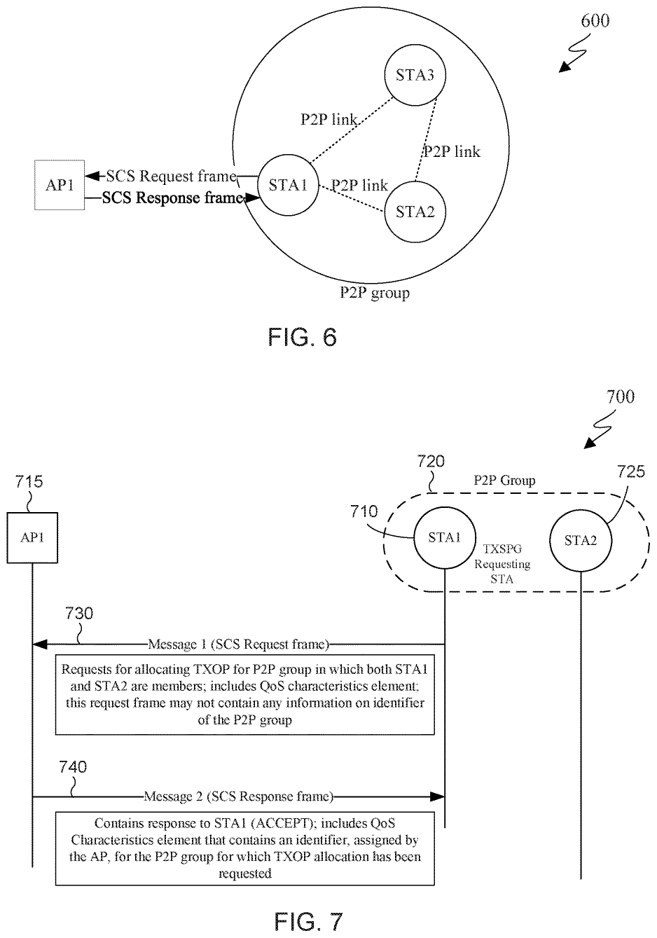

FIG. 6 illustrates a diagram 600 for exchanges of the SCS Request/Response frames for TXOP allocation request/response in TXSPG operation according to embodiments of the present disclosure. For example, the exchanges may occur in a network such as network 100 between AP(s) and STAs, such as STAs 111-114 and APs 101-103. The embodiment of the example shown in FIG. 6 is for illustration only. Other embodiments could be used without departing from the scope of this disclosure.

As illustrated in FIG. 6, a STA of the P2P group (e.g., a TXSPG requesting STA) may transmit an SCS request frame to the AP1.

In various embodiments, an identifier for a P2P group is assigned by the AP1.

In various embodiments, after receiving a TXSPG, if the AP1 accepts the request, in the response frame, the AP1 can assign the identifier for the P2P group value for the P2P group for which the request has been made by the non-AP STA.

In various embodiments, when a TXSPG non-AP STA sends an SCS request frame to an associated AP in order to request for TXOP for a P2P group in which the non-AP STA is a member, and wants to set up a new SCS agreement (i.e., the request is a new request (i.e., the Request Type field in the SCS Descriptor element containing the QoS Characteristics element is set to 0 (Add))) with the AP for the P2P group, then the identifier for the P2P group field of the P2P Group Information field in the QoS Characteristics element included in the SCS Request frame transmitted by the TXSPG non-AP STA is reserved. In other words, in such a case, the TXSPG non-AP STA shall not fill in the identifier for the P2P group field value in the QoS characteristics element.

In various embodiments, when a TXSPG non-AP STA sends an SCS request frame to an associated AP in order to modify or update an existing TXSPG SCS agreement, requesting TXOP allocating for a P2P group in which the non-AP STA is a member, and wants to update the corresponding SCS agreement (i.e., the request is an update/modify request (i.e., the Request Type field in the SCS Descriptor element containing the QoS Characteristics element is set to 2 (Change))) with the AP for the P2P group, then the identifier for the P2P group field of the P2P Group Information field in the QoS Characteristics element included in the SCS Request frame transmitted by the TXSPG non-AP STA shall be set to the same value of the identifier for the P2P group that was assigned for the P2P group for the corresponding SCS agreement set up earlier for TXOP allocation for that P2P group.

In various embodiments, when a TXSPG non-AP STA sends an SCS request frame to an associated AP in order to teardown or terminate an existing TXSPG SCS agreement, (requesting TXOP allocating for a P2P group in which the non-AP STA is a member), and wants to remove the corresponding SCS agreement (i.e., the request is delete or remove the SCS agreement (i.e. the Request Type field in the SCS Descriptor element containing the QoS Characteristics element is set to 1 (Remove))) with the AP for the P2P group, then the identifier for the P2P group field of the P2P Group Information field in the QoS Characteristics element included in the SCS Request frame transmitted by the TXSPG non-AP STA shall be set to the same value of the identifier for the P2P group that was assigned for the P2P group for the corresponding SCS agreement set up earlier for TXOP allocation for that P2P group.

FIG. 7 illustrates a flow diagram of a process 700 for an SCS response that carries an identifier using SCS Request/Response frames according to embodiments of the present disclosure. The process 700 of FIG. 7 can be performed between any one of the APs 101-103 of FIG. 1, such as AP 101 of FIG. 2A and any of the STAs 111-114 of FIG. 1, such as the STA 111 of FIG. 2B. The process 700 is for illustration only and other embodiments can be used without departing from the scope of the present disclosure.

As shown in FIG. 7, the STA1 (710) transmits, to the AP1 (715), a message 1 (e.g., using an SCS request frame) (730). For example, in 730, the SCS Request frame requests for allocating TXOP for the P2P group (720) in which both STA1 (710) and STA2 (725) are members. The SCS request frame contains a QoS Characteristics element. Upon receiving the SCS Request frame from the TXSPG non-AP STA requesting TXOP sharing for the P2P group (TXSPG), if the AP1 (715) accepts the request, then the AP1 (715) transmits a message 2 (e.g., a SCS Response frame) (740). The SCS Response frame can carry a QoS Characteristics element that contains a P2P Group Information field. In the P2P Group Information field the AP can indicate the identifier for the P2P group that the AP assigns for the P2P group for which the TXSPG non-AP STA has sent the SCS Request frame. The other fields of the P2P Group Information field of the SCS Response frame can be the same as that carried in the SCS Request frame received from the non-AP STA.

In various embodiments, upon receiving the SCS Request frame from the TXSPG non-AP STA requesting TXOP sharing for the P2P group (TXSPG), if the AP accepts the request, then the AP in the SCS Response frame can carry a QoS Characteristics element that contains a P2P STA AID List field. The contents of the P2P STA AID List field in the QoS Characteristics element in the SCS Response frame can be the same as the P2P Group Information field in the QoS Characteristics element carried in the SCS Request frame received from the non-AP STA. According to another embodiment, The contents of the P2P STA AID List field in the QoS Characteristics element in the SCS Response frame can be different from the P2P Group Information field in the QoS Characteristics element carried in the SCS Request frame received from the non-AP STA.

In various embodiments, upon receiving the SCS Request frame from the TXSPG non-AP STA requesting TXOP sharing for the P2P group (TXSPG), if the AP rejects the request, then the AP in the SCS Response frame can carry a QoS Characteristics element that contains a P2P Group Information field, the P2P Group Information field in the QoS Characteristics element can be reserved.

In various embodiments, upon receiving the SCS Request frame from the TXSPG non-AP STA requesting TXOP sharing for the P2P group (TXSPG), if the AP rejects the request, then the AP in the SCS Response frame may not carry a QoS Characteristics element that contains a P2P Group Information field.

In various embodiments, upon receiving the SCS Request frame from the TXSPG non-AP STA requesting TXOP sharing for the P2P group (TXSPG), if the AP reject the request, then the AP in the SCS Response frame can carry a QoS Characteristics element that contains a P2P STA AID List field. The contents of the P2P STA AID List field in the QoS Characteristics element in the SCS Response frame can be the same as the P2P Group Information field in the QoS Characteristics element carried in the SCS Request frame received from the non-AP STA. According to another embodiment, The contents of the P2P STA AID List field in the QoS Characteristics element in the SCS Response frame can be different from the P2P Group Information field in the QoS Characteristics element carried in the SCS Request frame received from the non-AP STA.

In various embodiments, upon receiving the SCS Request frame from the TXSPG non-AP STA requesting TXOP sharing for the P2P group (TXSPG), if the AP reject the request, then the AP in the SCS Response frame may not carry a QoS Characteristics element that contains a P2P STA AID List field.

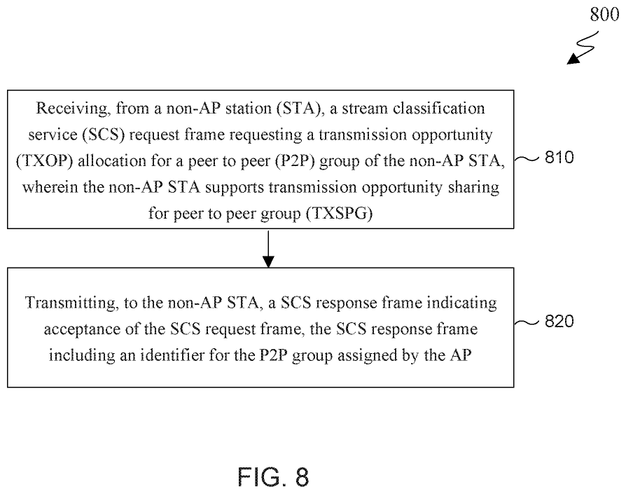

FIG. 8 illustrates an example method 800 for performed by an AP according to embodiments of the present disclosure. The method 800 of FIG. 8 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 800 is for illustration only and other embodiments can be used without departing from the scope of the present disclosure.

The method 800 begins at step 810 where the AP receives, from a non-AP STA, an SCS request frame requesting a TXOP allocation for a P2P group of the non-AP STA, where the non-AP STA supports TXSPG. At step 820, the AP transmits, to the non-AP STA, a SCS response frame indicating acceptance of the SCS request frame, the SCS response frame including an identifier for the P2P group assigned by the AP.

In some embodiments, the AP receives, from the non-AP STA, information indicating setup of a new SCS agreement with the AP, wherein a value of an identifier for the P2P group in a P2P group information field in a quality of service (QoS) characteristics element included in the SCS request frame is reserved.

In some embodiments, the information indicating setup of a new SCS agreement with the AP includes a request type field in a SCS descriptor element that includes the QoS characteristics element being set to 0.

In some embodiments, the SCS request frame includes information indicating a change or modification or teardown/removal of an existing TXSPG SCS agreement with the AP, wherein a value of an identifier for the P2P group in a P2P group information field in a QoS characteristics element included in the SCS request frame is same as a value of an identifier for the P2P group that was assigned for the P2P group used for the existing TXSPG SCS agreement.

In some embodiments, the SCS response frame includes a QoS characteristics element.

In some embodiments, the QoS characteristics element in the SCS response frame includes a P2P group information field.

In some embodiments, the P2P group information field includes the identifier for the P2P group assigned by the AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by an access point (AP), the method comprising:
receiving, from a non-AP station (STA), a stream classification service (SCS) request frame requesting a transmission opportunity (TXOP) allocation for a peer to peer (P2P) group of the non-AP STA, wherein the non-AP STA supports transmission opportunity sharing for peer to peer group (TXSPG); and
transmitting, to the non-AP STA, a SCS response frame indicating acceptance of the SCS request frame, the SCS response frame including an identifier for the P2P group assigned by the AP.

2. The method of claim 1, further comprising receiving, from the non-AP STA, information indicating setup of a new SCS agreement with the AP, wherein a value of an identifier for the P2P group in a P2P group information field in a quality of service (QoS) characteristics element included in the SCS request frame is reserved.

3. The method of claim 2, wherein the information indicating setup of a new SCS agreement with the AP includes a request type field in a SCS descriptor element that includes the QoS characteristics element being set to 0.

4. The method of claim 1, wherein the SCS request frame includes information indicating a change or modification or teardown/removal of an existing TXSPG SCS agreement with the AP, wherein a value of an identifier for the P2P group in a P2P group information field in a quality of service (QoS) characteristics element included in the SCS request frame is same as a value of an identifier for the P2P group that was assigned for the P2P group used for the existing TXSPG SCS agreement.

5. The method of claim 1, wherein the SCS response frame includes a quality of service (QoS) characteristics element.

6. The method of claim 5, wherein the QoS characteristics element in the SCS response frame includes a P2P group information field.

7. The method of claim 6, wherein the P2P group information field includes the identifier for the P2P group assigned by the AP.

8. A method performed by a non-access point (AP) station (STA), the method comprising:
transmitting, to an AP, a stream classification service (SCS) request frame requesting a transmission opportunity (TXOP) allocation for a peer to peer (P2P) group of the non-AP STA, wherein the non-AP STA supports transmission opportunity sharing for peer to peer group (TXSPG); and
receiving, from the AP, a SCS response frame indicating acceptance of the SCS request frame, the SCS response frame including an identifier for the P2P group assigned by the AP.

9. The method of claim 8, further comprising transmitting, to the AP, information indicating setup of a new SCS agreement with the AP, wherein a value of an identifier for the P2P group in a P2P group information field in a quality of service (QoS) characteristics element included in the SCS request frame is reserved.

10. The method of claim 9, wherein the information indicating setup of a new SCS agreement with the AP includes a request type field in a SCS descriptor element that includes the QoS characteristics element being set to 0.

11. The method of claim 8, wherein the SCS request frame includes information indicating a change or modification or teardown/removal of an existing TXSPG SCS agreement with the AP, wherein a value of an identifier for the P2P group in a P2P group information field in a quality of service (QoS) characteristics element included in the SCS request frame is same as a value of an identifier for the P2P group that was assigned for the P2P group used for the existing TXSPG SCS agreement.

12. The method of claim 8, wherein the SCS response frame includes a quality of service (QoS) characteristics element.

13. The method of claim 12, wherein the QoS characteristics element in the SCS response frame includes a P2P group information field.

14. The method of claim 13, wherein the P2P group information field includes the identifier for the P2P group assigned by the AP.

15. An access point (AP), comprising:
at least one processor including processing circuitry; and
memory storing instructions, wherein the instructions, when executed by the at least one processor individually or collectively, cause the AP to:
receive, from a non-AP station (STA), a stream classification service (SCS) request frame requesting a transmission opportunity (TXOP) allocation for a peer to peer (P2P) group of the non-AP STA, wherein the non-AP STA supports transmission opportunity sharing for peer to peer group (TXSPG); and
transmit, to the non-AP STA, a SCS response frame indicating acceptance of the SCS request frame, the SCS response frame including an identifier for the P2P group assigned by the AP.

16. The AP of claim 15, wherein the instructions, when executed by the at least one processor individually or collectively, cause the AP to receive, from the non-AP STA, information indicating setup of a new SCS agreement with the AP, wherein a value of an identifier for the P2P group in a P2P group information field in a quality of service (QoS) characteristics element included in the SCS request frame is reserved.

17. The AP of claim 16, wherein the information indicating setup of a new SCS agreement with the AP includes a request type field in a SCS descriptor element that includes the QoS characteristics element being set to 0.

18. The AP of claim 15, wherein the SCS request frame includes information indicating a change or modification or teardown/removal of an existing TXSPG SCS agreement with the AP, wherein a value of an identifier for the P2P group in a P2P group information field in a quality of service (QoS) characteristics element included in the SCS request frame is same as a value of an identifier for the P2P group that was assigned for the P2P group used for the existing TXSPG SCS agreement.

19. The AP of claim 15, wherein the SCS response frame includes a quality of service (QoS) characteristics element.

20. The AP of claim 19, wherein the QoS characteristics element in the SCS response frame includes a P2P group information field.
